(19) United States
(12) Patent Application Publication
(10) Pub. No.: US 2023/0217906 A1
(43) Pub. Date: Jul. 13, 2023

(54) AQUACULTURE MONITORING SYSTEM AND METHOD

(71) Applicant: WOODS HOLE OCEANOGRAPHIC INSTITUTION, Woods Hole, MA (US)

(72) Inventor: Yogesh Girdhar, Woods Hole, MA (US)

(73) Assignee: WOODS HOLE OCEANOGRAPHIC INSTITUTION, Woods Hole, MA (US)

(21) Appl. No.: 18/009,273

(22) PCT Filed: Nov. 15, 2021
(86) PCT No.: PCT/US21/59385

§ 371 Date: Dec. 8, 2022

Related U.S. Application Data
(60) Provisional application No. 63/114,040, filed on Nov. 16, 2020.

(51) Int. Cl. A01K 61/10; G06T 7/593; A01K 61/95

(52) U.S. Cl. CPC A01K 61/10; G06T 7/593; A01K 61/95

(57) ABSTRACT

An apparatus, system, and method of use for capturing data on an environment and determining a parameter of that environment. The apparatus having a housing, a sensor, and a controller, the sensor capturing data pertaining to the environment, the controller processing, by a data processing pipeline, the data to determine or estimate a parameter of the environment. In one embodiment of the present invention, the apparatus captures data on aquaculture environments and estimates parameters relating to underwater creature such as fish biomass, fish feeding state, or fish satiation score.

### CROSS-REFERENCE TO RELATED APPLICATIONS

This application claims priority to the Provisional U.S. Patent Application No. 63/114,040 filed Nov. 16, 2020.

### BACKGROUND OF THE INVENTION

### Field of the Invention

This application relates to environmental monitoring. More specifically, this invention relates to automated environmental monitoring with the purpose of determining or estimating a parameter in the observed environment, with some embodiments of the invention relating to the automated monitoring of underwater scenes of aquaculture environments.

### Background Information

Offshore, free standing, aqua culture farms provide many benefits over static, near shore farms. They can however be expensive to maintain due to the cost of human involvement in maintaining and monitoring them. Disclosed herein are techniques to enable automatic characterization of the state of these fish farms using computer vision techniques.

Underwater imaging and resource management is an important and growing field. Underwater environments are used for fisheries resources, exploration, research, environmental monitoring, and energy extraction. Many researchers are observing fish habitat or fish species changes to protect and efficiently use marine resources. For example, changes in species in certain areas can be used as an indicator of climate in other, non-aquaculture activities as well.

Underwater fish monitoring is also important in the fast-growing aquaculture industry. Of the various types of underwater monitoring, underwater optical vision is the most information rich method for underwater sensing. Automatic vision-based object detection can provide important information to understand the marine ecosystem and environment.

However, a common problem of underwater, automatic vision-based detection is the automatic characterization and classification of the desired objects (e.g., fish) within an image and using those detection events to determine or estimate important parameters about the desired object captured on the image.

Thus, a solution is needed that comprises an automated, preferably machine learning, method of analyzing images to determine the state of an environment (e.g., a fish farm), using image data captured by an underwater sensor (e.g., a camera).

### SUMMARY OF THE INVENTION

Here is described an inventive system using an underwater sensor and machine learning to determine parameters of an environment of interest, for instance, the biomass of imaged fish, the biomass of a larger fish farm, and the satiation state of said imaged fish.

The invention also includes a method for using the system to evaluate and estimate parameters of the fish farm environment. The method comprises generally of placing a detector in the environment so that it captures environmental data which is stored or transmitted to a data processer. The data processor executes a data processing pipeline comprising a plurality of nodes. The nodes or functions are selected by the user, executed, and then used to determine or estimate a given parameter such as feeding times and satiation of the fish in a fish farm.

### BRIEF DESCRIPTION OF THE DRAWINGS

The drawings constitute a part of this specification and include exemplary embodiments of the Aquaculture Monitoring System and Method, which may be embodied in various forms. It is to be understood that in some instances, various aspects of the invention may be shown exaggerated or enlarged to facilitate an understanding of the invention. Therefore, the drawings may not be to scale.

FIG. 1A shows a view of one embodiment of a detector according to the present invention.

FIG. 1B shows a second view of one embodiment of a detector according to the present invention.

FIG. 2 is a flow diagram of operation of one embodiment according to the present invention.

FIG. 3A is a confusion matrices of classification results from a possible data processing pipelines to determine the parameter of satiation.

FIG. 3B is a confusion matrices of classification results from another possible data processing pipelines to determine the parameter of satiation.

FIG. 4 is an exemplary image of data captured by a sensor according to one embodiment with annotations from the data processing pipeline.

FIG. 5 is a confusion matrix showing the average performance of one classifier in one processing pipeline according to the present invention.

FIG. 6A is a graphical representation of the performance of a processing pipeline, according to one embodiment.

FIG. 6B is another graphical representation of the performance of a processing pipeline, according to one embodiment.

FIG. 7A is a graphical representation of a processing pipeline according to one embodiment, wherein the processing pipeline uses data encoded with different color information, namely grey scale.

FIG. 7B is a graphical representation of a second processing pipeline according to one embodiment, wherein the processing pipeline uses data encoded with different color information, namely RGB.

FIG. 7C is a graphical representation of a third processing pipeline according to one embodiment, wherein the processing pipeline uses data encoded with different color information, namely optical.

FIG. 7D is a graphical representation of a fourth processing pipeline according to one embodiment, wherein the processing pipeline uses data encoded with different color information, namely a combination of all.

FIG. 8A is a graphical representation of a processing pipelines with different learning rates and different training times.

FIG. 8B is another graphical representation of a processing pipeline with different learning rates and different training times

FIG. 9A is a graphical illustration of predicted satiation levels during a given feeding event using one processing pipeline, according to the present invention.

FIG. 9B is a graphical illustration of predicted satiation levels during a given second feeding event using one processing pipeline, according to the present invention.

FIG. 9C is a graphical illustration of predicted satiation levels during a given third feeding event using one processing pipeline, according to the present invention.

FIG. 9D is a graphical illustration of predicted satiation levels during a given fourth feeding event using one processing pipeline, according to the present invention.

FIG. 9E is a graphical illustration of predicted satiation levels during a given fifth feeding event using one processing pipeline, according to the present invention.

### DETAILED DESCRIPTION OF THE INVENTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

The present disclosure describes systems and methods for environment monitoring, preferably comprising distinct objects within the environment. One aspect of the present disclosure is the estimation of the mass of an environment, e.g. biomass in an aquaculture farm.

Another aspect of the present invention is the satiation estimation of animals in an environment (e.g., an aquaculture farm).

In an embodiment, the monitoring system comprises a detector 0 for imaging objects (e.g., fish) in an environment and a computer for estimating at least one parameter of the environment. The detector 0 most often comprises a water-tight housing, a stereo sensor (e.g., camera) 6, a controller 4, a power source 2, and connectors 5. The sensor 6 sends data of the environment to the controller 4, the controller 4 may then either store the data for later processing, either by controller 4 or by another device, or may process the data to determine a parameter relating to the environment by using the data.

It is within the scope of the present invention for the system to encode as a non-transient computer readable medium. The medium instructing a controller to receive data of the environment, to construct a processing pipeline using a number of nodes available, each node changing, processing or transforming the data in some way, each node producing a data product, the final node producing processed data, and the medium instructing the controller to analyse said data with the processing pipeline, producing the processed data and to estimate a parameter of the environment using the processed data.

Detector

The present disclosure provides for a detector 0 enabling the capture of data of an environment. Once the data is captured, it may be processes and used to determine or estimate at least one parameter about the environment. The detector 0 may be any apparatus as known in the art, as long as it enables data capture of the environment and connectivity to a processor to process or manipulate the data. Data processing may be ‘online’, meaning it occurs on the detector itself or it may be ‘offline’, meaning it occurs on another device, often at a later time than data capture.

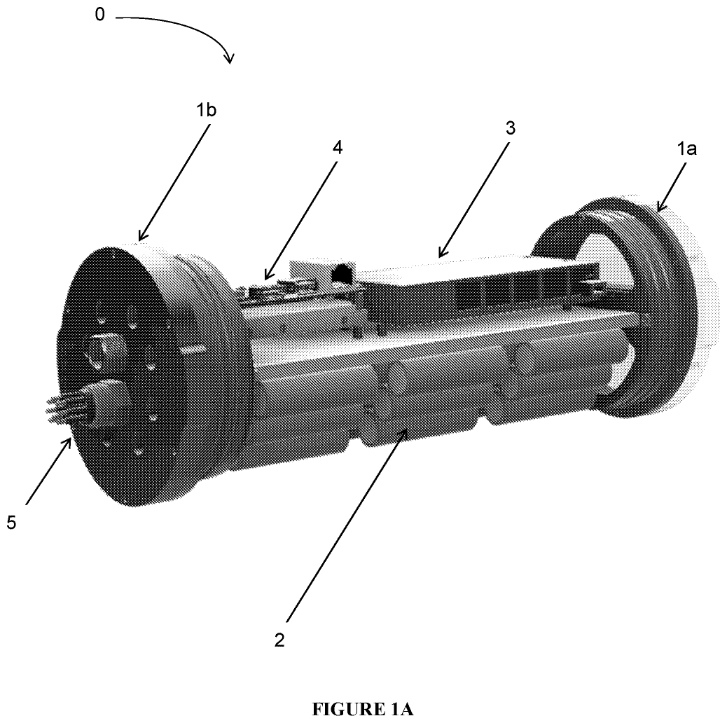

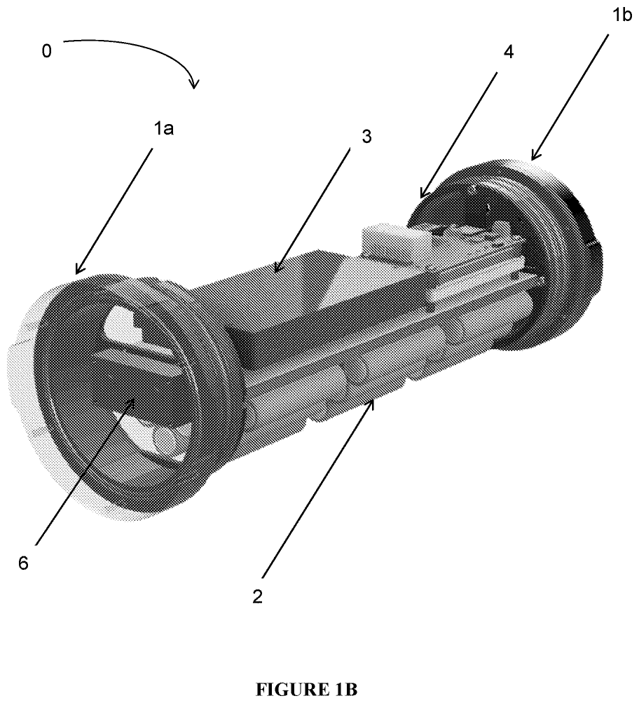

A preferred embodiment of a detector 0 is shown in FIGS. 1A and 1B. As shown, the detector 0 has an underwater stereo sensor 6, disposed within a water-tight housing, with an onboard controller 4, a power source 2, and optionally, connectors 5. Data processing may occur within the detector 0, on the onboard controller 4, or may occur on a connected device, the data being transferred from the detector 0 via the connectors 5 in a machine-readable format.

In an exemplary embodiment, the housing comprises two end caps 1a, 1b and a housing. In one embodiment, a commercially available cap and housing may be used, for example, BlueROV 6-inch caps and housing from Blue Robotics of Torrance Calif., USA.

The power source 2 comprises any suitable battery pack solution as known in the art. Alternatively, the power source may be run to the unit via conduit, particularly in near land applications. The sensor 6 comprises a commercially available camera. In one embodiment, the sensor 6 comprises a ZED-Mini camera from Stereo Labs, enabling greater than 15 frames per second disparity computation at high resolution (1280×720) while using only onboard processing (i.e., with the controller 4). In other embodiments, other sensors may be used, such as a Duo3D stereo camera, commercially available from Code Laboratories of Henderson, Nev., USA.

One or more embodiments also comprise a power over ethernet and fiber optic capable ethernet hub for communications. The connectors 5 may be any suitable mechanism as known in the art. In one embodiment, the connectors 5 are standard RS-232 connectors. In other embodiments, the connectors 5 may be other wired connectors or may be wireless, as known in the art. In some embodiments, the connectors 5 also provide at least a portion of the power (i.e. electricity) to the system.

The detector 0 apparatus may be mountable on a structure (e.g., a fish pen, platform, buoy, etc.). The detector 0 may be mountable on any suitable structure as known in the art, including a remotely operated vehicle (“ROV”), autonomous underwater vehicle (“AUV”), an unmanned aerial vehicle (“UAV”), a diver operated vehicle, a vessel, and the like.

Controller

In one or more embodiment, the controller 4 may comprise a digital control device, generically referred to herein as a “controller” that is provided to control various aspects of the system. The controller 4 may be any digital controlling system, configured to give commands and to receive information from various components of the system, as well as components outside the system (e.g., a connected external controller or data storage).

The controller 4 enables real-time operational control of the system by receiving and storing data from the sensor 6, instructing the operation of the sensor 6, receiving communications through the connectors 5, storing data, instructing communication sending, keeping a software-based clock, or connecting to a hardware clock, and changing parameters or settings of any of the interconnected components. Furthermore, the controller 4 is configured to receive commands or data from external sources, often through the connectors 5.

The controller 4 is powered by the power source and is informationally connected to at least the sensor 6 and the connectors 5. In one embodiment, the controller 4 is further connected to the communications mechanism. In one embodiment, the controller 4 comprises a NVIDA Jetson TX2 computing platform. In one embodiment, the processing pipeline is executed onboard the controller 4. This enables transmission of the processing pipeline's result using extremely low bandwidth communications, for example acoustic communications or Iridium SMS messages.

Communications

The present disclosure provides for a communications mechanism 3 to send data or other information from the device 0 to a remote location. The communications mechanism 3 may be any suitable means as known in the art. In one embodiment the communications mechanism 3 is an acoustic modem. In other embodiment the communications mechanism 3 is a satellite communication means.

Sensor

The present disclosure provides for a mechanism to capture or otherwise record information about the environment and is referred herein as the sensor 6. The sensor 6 may be any suitable mechanism as known in the art. It should be noted that the term “sensor” is used for simplicity and may encompass additional devices that capture data of an environment, for example a still image camera, a video camera, a microphone, a hydrophone, or a conductivity temperature and density sensor (“CTD”). In one embodiment, the sensor 6 is a stereo camera. Preferably, the sensor 6 will capture still images of the environment. Sensor 6 is powered by the power supply 2 or by the connectors 5. Sensor 6 is operatively connected to the controller 4, may send captured environmental data to the controller 4, and may accept commands from the controller 4. In some embodiments, more than one sensor 6 is included in the detector 0, with the additional sensors typically being connected to the controller 4 and powered by the power source 2 or connectors 5.

Data Processing Pipeline

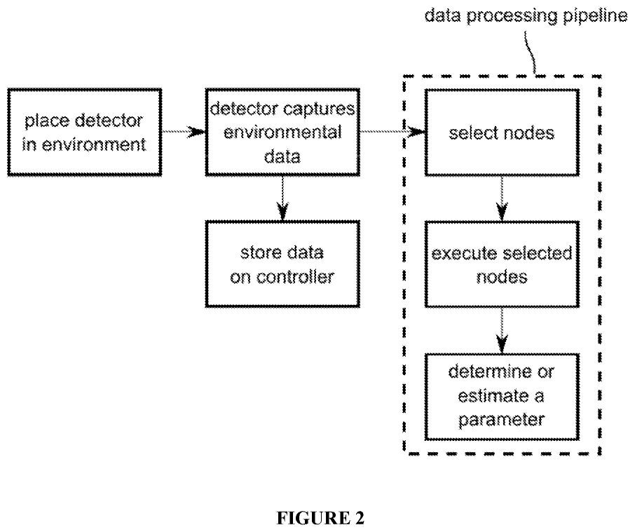

The present disclosure provides for a means for processing the data captured by the sensor 6—referred generically herein as processing or processing pipeline—enabling the determination or estimation of at least one environmental parameter and is shown in FIG. 2.

The processing pipeline may physically occur in any suitable location and may take any suitable form as long as it is capable of making a determination or estimation of at least one environmental parameter.

In one embodiment, the processing occurs on the controller 4. In other embodiments, the sensor's data is transferred out of the apparatus via the connector 5 and is processed on a separate controller (e.g., a data center).

In one embodiment, the form of data processing comprises open source libraries such as robotic operating (“ROS”), OpenCV, and Tensorflow. ROS-based processing software enables a modular and adaptable processing pipeline structure that enables additional processing and sensing capabilities to the processing pipeline.

Software steps within the processing pipelines are referred to herein as “nodes”. The nodes may be selected and ordered by a user to conduct the processing pipeline. FIG. 2 depicts the selection and execution of the nodes as part of the data processing pipeline in order to determine or estimate a given parameter.

In embodiments with a stereo camera, the processing pipeline has nodes configured to convert stereo image pairs to depth maps, and may also have nodes to determine which depth maps are most suitable for observing scenes of densely packed objects (e.g., dense fish populations), and these steps represent adaptable nodes in the processing pipeline. One or more nodes is optional in the pipeline and may be added as needed by a user.

One node in the processing pipeline is a machine learning-based technique for detecting individual objects, often by programmatically assigning each object a bounding area—also commonly known as a “bounding box”.

In one or more embodiments, the processing pipeline may also include training nodes to limit the detection of objects—such as at a certain angle or stance. For example, in one embodiment, the node only assigns bounding areas on fish (the objects) that are imaged with straight bodies and not bent bodies. This node increases the accuracy of object parameter estimation, here fish length estimates.

In one or more embodiments, one or more nodes in the pipeline enable the identification of key points on objects. These key points may be used in combination with 3D models to estimate object parameters; for example, key points in fish morphology, in combination with pre-defined fish 3D models to estimate fish length. Fish length may comprise the entire length of a fish, or the length of a subset or multiple subsets of the fish, for example, head length or tail length. Additional examples of key points include points along the mouth of a fish and points along the notch in the tail of a fish.

In one or more embodiments, additional nodes establish additional parameters. In one embodiment, a node establishes a regression that estimates fish mass given fish length (information produced by an upstream node, described above) for a given species of fish.

Additional nodes may convert a parameter estimation into a different readout, for example a chance value or percentage may be converted into a binary, a yes or no parameter. In another embodiment, a parameter may be converted into a range of values, for example a score between 0 and 1.

In one embodiment, the processing pipeline analyzes data and classifies the data, for example the gathered images, into one of three categories, pre-feeding, during-feeding, or post-feeding. A set of nodes then transforms that classification output, or additional data into a scale ranging from 0 to 1 for a satiation estimate. Both the classification of the data and the satiation estimate are representative parameters of the environment, where the feeding state and station state reflect objects and object's behaviors in the environment.

One major hurdle encountered in the art has been parameter estimation due to lack of complete visibility of an object, often in scenes of densely packed objects. The processing pipeline disclosed herein solves this problem by estimating additional parameters and then estimating the final parameter using those additional parameters.

As an example, in one embodiment, the pipeline produces a first parameter of object mass, and a second parameter of expected number of objects to produce an average of object mass and multiplies that by the expected number of objects to get the overall object mass in an environment (e.g., the biomass of a fish farm equals average fish mass multiplied by the expected number of fish). Furthermore, assuming the number of original objects is known, and the objects have a relatively constant loss and generation rate, the number of objects at any time may be estimated.

In most cases, the processing pipeline will operate with data received from the sensor. However, it is within the scope of the present invention for the processing pipeline to operate with data from another source, for example a prepared or archival data set of compatible imagery or other data. Additional data processed by the pipeline includes training data where certain parameters are already known and are conveyed to the pipeline. The number of images or other sensor data needed within a training set largely depends on the variability of the environment.

Additional nodes may include methods to detect anomalies in the data or enabling rare event or rare parameter detection: for example, perimeter breaches, diseases, infestations, or structural integrity of objects in the environment.

In some instances, the processing pipeline analyzes sensor 6 data independently (e.g., a single image), or pairs of data (e.g., consecutive images) to determine or estimate a parameter. In these instances, a broader temporal context of the environment is not considered.

In one or more embodiments, time is taken into consideration by analyzing data as a sequence (e.g., a series of images), accounting for the temporal sequence of the data. A parameter is tracked over the data sequence. Techniques such as particle filters in combination with the convolutional neural network (CNN) disclosed herein are used to achieve temporal considerations. In other embodiments, a recurrent neural network (RNN) such as LSTM (long short-term memory) networks, which are designed for sequential data, are used.

Parameters

The present invention provides an apparatus, method, and system to determine or estimate many different parameters, when data about the environment containing the parameters is captured by the sensor 6. A non-limiting set of exemplary parameters includes object length, object mass, average object mass, total mass of a set of objects, biomass, object satiation, actions occurring in the environment such as when feeding begins.

### Example 1

A first example of one embodiment of the present invention is presented here. This example focuses on the processing pipeline and accepts data from a suitable sensor 6 that captures data of an aquaculture environment. In this example, the processing pipeline adopts the Inception-v3 network for the classification tasks. The processing pipeline is pre-trained, or uses transfer learning, wherein the pipeline has been trained to classify upwards of thousands of different categories or parameters, and then is only retrained on the top few layers of the dataset, for instance, data from the sensor. Here, the pre-trained pipeline does not need to learn or be re-trained on various low level representations of images that are common to all natural images, and only focuses on learning high level representations of the type of images that are observed for this environment, an aquaculture farm. This method reduces training time from over thousands of images to less than an hour using a standard controller.

In this example, a data set was provided to the processing pipeline, comprising video clips from ten different days with three different camera positions per day. The video for a given day and sensor position was saved as multiple video files. Video files were concatenated into one large file per day and sensor position. The time was recomputed for the beginning and ending of feeding events, relative to the beginning of the video file.

Thousands of subsample image frames were extracted from the videos, corresponding to each of the three states of interest: pre-feeding, feeding, and post-feeding of the fish. These images are then used for training and testing the processing pipeline. Raw images were extracted from the video at 1 fps and had a resolution of 2704×1520. These images were then resized to 299×299 as a tensor for training.

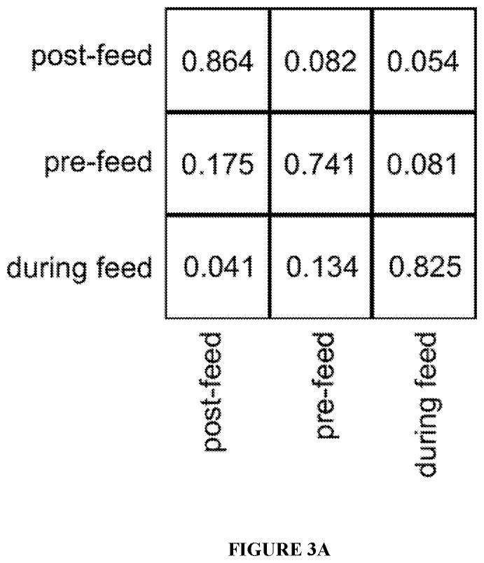

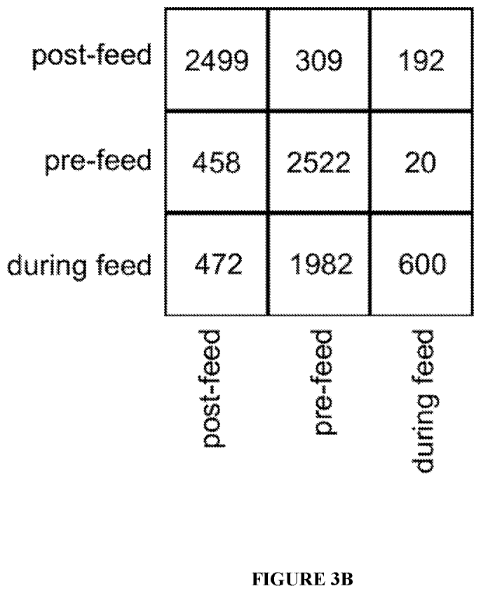

Four datasets are provided, three were used for pipeline training and the fourth for testing. FIG. 3A shows a confusion matrix computed by averaging the results from all four datasets, were the x-axis is the predicted parameters and the y-axis is the actual parameters. The numbers displayed are the average prediction score for each parameter. These results suggest that the classifier (the pipeline) generalizes well to change between the datasets here, direction of a camera.

FIG. 3B shows an additional experiment with training and test datasets on the parameter of fish satiation; axes are the same as in FIG. 3A. The processing pipeline results in 62% accuracy for the parameter of satiation detection based on still images captured by a camera in a detector. These results are from a pipeline using an Inception-v3 network architecture with transfer learning—i.e., training only the op softmax layer for classification.

Conditions of the environment that affect this example include detector and fish farm configuration, including for instance: size, shape, ocean depth, ocean currents, water turbidity and the parameters most suitable to measure and estimate in these configurations. Parameters of interest for this example include, but are not limited to, fish length, fish mass, overall biomass, feeding beginning action, satiation, and feeding ending.

The processing pipeline in this example includes nodes to train and determine a deep network on the entire captured image and directly predicting the parameters such as feeding states, or training and determining a neural network to detect various components or objects of the scene such as the feeding tube, fish school, feed, or individual fish first, and then training another set of nodes often grouped and referred to as a classifier that builds upon this scene component classifier to detect higher level scene parameters or feeding events; or incorporating motion through optical flow in addition to appearance through still image to characterize satiation and other parameters.

Other pipeline processing options include fish classifiers using different neural networks, for example the You Only Look Once (“YOLO”) architecture, thus enabling the analysis of motion of individual fishes. The pipeline applies bounding areas of viable fishes and then quantifies the tracks. Training data was conducted with manual bounding areas of fish. In densely packed scenes, accurate pipeline detection of fish is possible but best results occur when density is not too high.

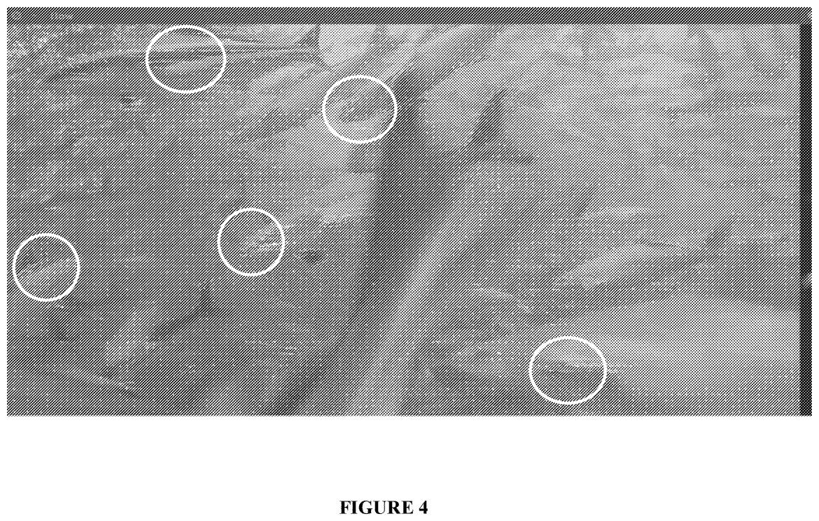

Another pipeline processing option includes using motion information, as computed using an optical flow algorithm, for classifying environmental states or cage states. A processing pipeline using the Gunner Farneback's algorithm for optical flow detect fish movement magnitude and direction of change, is shown in FIG. 4. FIG. 4 shows hashed white lines (white circles show exemplary white lines for clarification purposes) indicating all computed changes in the current frame. The same data may be presented in a hue-saturated space where intensity is magnitude and colors correspond to direction on a HSV color wheel.

### Example 2

In a second exemplary embodiment, the processing pipeline is based on a variants of the inception v3 network architecture. The original Inception-v3 network is designed to classify images into 1,000 categories, corresponding to the classes in the ImageNet dataset. Although it is possible to design a simpler, smaller network to determine or estimate parameters such as satiation prediction, this embodiment mitigated the usual problems associated with the use of a large network by employing transfer learning. This embodiment initialized the network with weights from an ImageNet trained dataset, and then trained it to detect the three classes of states: feeding states: pre-feed, during, and post-feed.

In this example, the processing pipeline was trained on data from 18 feeding events. Only image data that corresponds to 20 minutes before feeding till 20 minutes after feeding has ended was considered. Images taken 20 minutes before the feeding began until the commencement of the feeding were annotated with the “pre-feeding” label; images during the feed were annotated with “feeding” label, and images from the end of feeding until 20 minutes after feeding ended were annotated with “post-feeding” label. The classifier was then trained with these annotations.

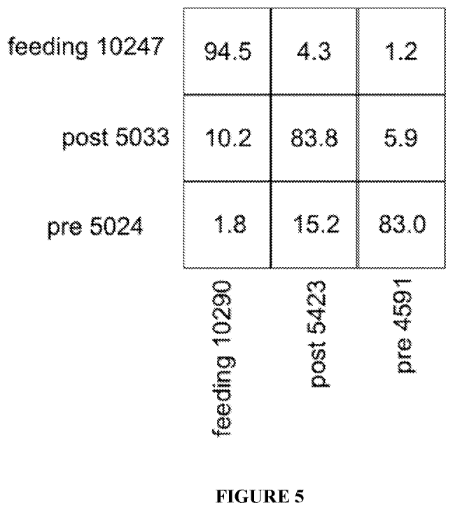

Since there was limited amount of data available, leave-one-day-out cross validation was used to evaluate the performance of the classifier most effectively. Given 18 feeding events, 18 different training sets were built, each consisting of all by one feeding event. The trained classifier was then used to classify each image from the held out feeding event. The results summarized with a confusion matrix showing the average performance of the classifier averaged over all days is shown in FIG. 5. An average accuracy of 94.5% for detecting the “feeding” state, 83.3% for “post-feeding” state, and 83.0% for “pre-feeding” state is shown. Performance of the classifier for each day varied but were like the average.

Most of the confusion, when it does exist, is between “pre-feeding” and “post-feeding” state. This makes sense as during feeding the fish form a dense school that is easily distinguishable. Furthermore, there are several days which have distinctly anomalous confusion matrices.

The results shown in FIG. 5 correspond to learning over grayscale input images of the feeding event. Each image was processed independently by the neural network, and hence no information related to the motion of the fish was present in the input data. Incorporating some motion related information into the network input provides improved results.

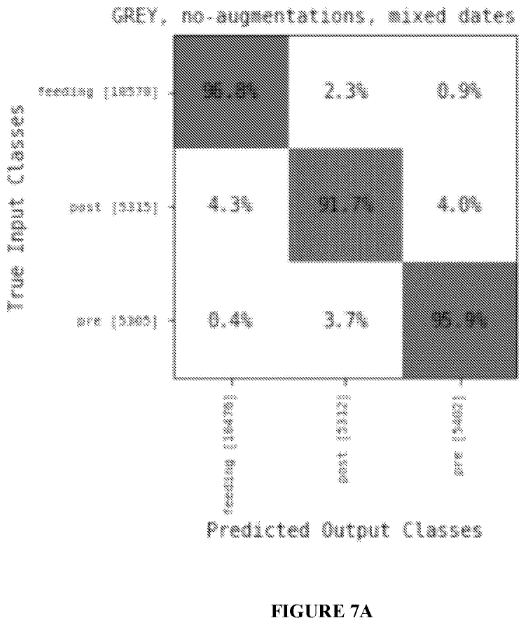

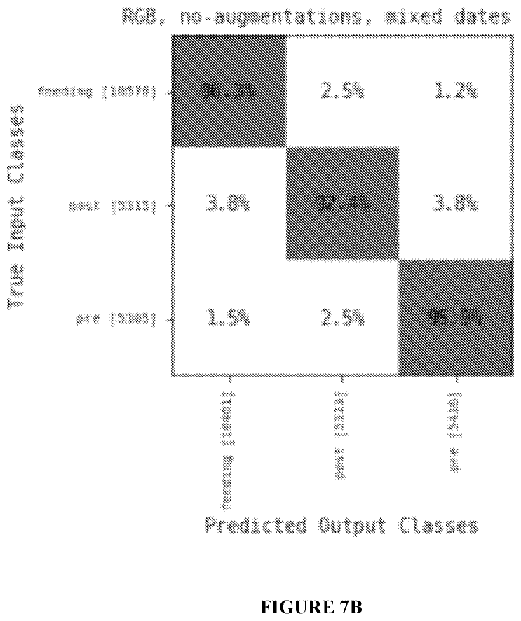

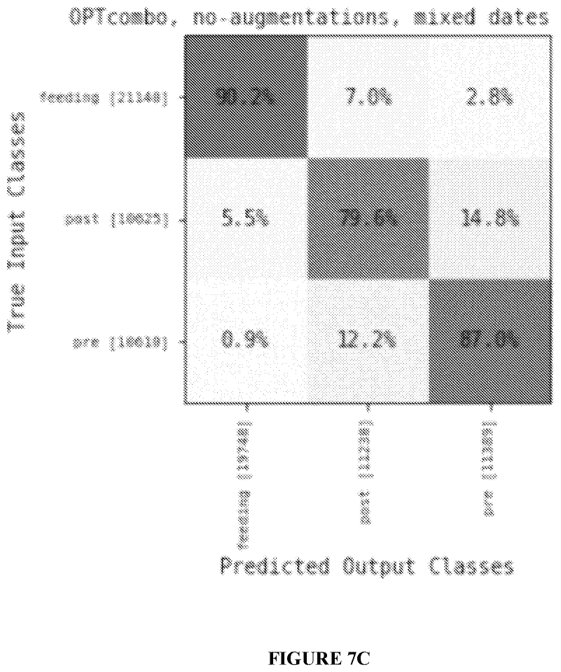

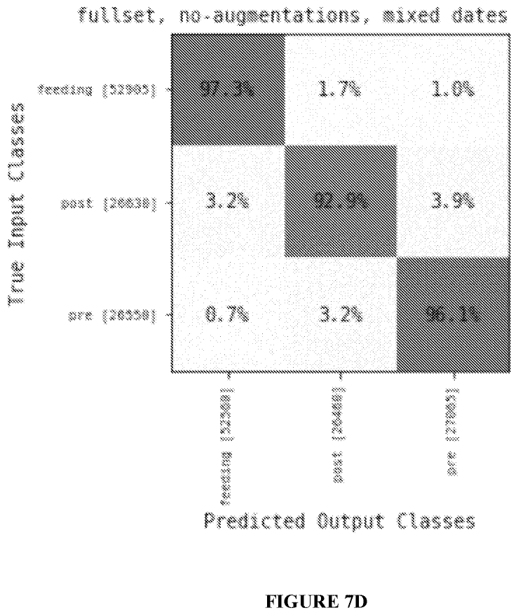

Use of color or optical flow does not improve the performance of the classifier in any significant way as illustrated in FIGS. 7A-7D. FIGS. 7A-7D show the performance of the classifier with input data that is greyscale (7A), RGB (7B), optical (7C), and combining all (7D). Use of optical flow or color adds only minor improvement to the classification results over greyscale input. Note that these experiments were done by randomly splitting the entire data into 80-20 split, corresponding to training and test data, i.e., leave-one-day-out cross-validation was not performed. As a result, the overall results appear more accurate than those presented in FIG. 5. As with the random 80-20 split, the training set is likely to contain images from the same day testing was performed. The results with leave-one-day-out cross-validation should be considered more representative of real-life performance, however the random 80-20 split approach is still useful, as it allows us to rapidly evaluate factors (such as colors or optical) that might affect performance.

Inception-net like networks can distinguish between different feeding states. Thus, the next step in this experiment was to prove that a variant of this network can predict a satiation score. Said another way, the results from the network output are demonstrated as follows: a score of 0 when fish have not yet started feeding, a score of 1.0 when they are fully satiated, and score between 0-1 while they are being fed.

Other prior art faced with a similar problem were hampered by the availability of ground truth annotation data with such satiation scores. A simple satiation model for the fish assumes that the satiation score grows linearly over the feeding period and maxes out at 1.0 when the fish are fully fed. This was used in this example.

The original Inception-v3 network is designed to classify images into 1,000 categories corresponding to the classes in the ImageNet dataset. The network was modified to output a single scalar value corresponding to the satiation score. The final fully-connected layer of the network (which has 1,000 outputs, one per class) was replaced with a new final fully-connected layer with a single output. The resultant value of that single final layer output is the predicted satiation value of the input image. The change was also applied to the auxiliary output, and the loss function that is applied during training. To train the model in the context of linear regression, a PyTorch's Mean Squared Error Loss function was used.

To train the network to estimate fish satiation score, the training dataset was created in the following manner. Only images taken 20 minutes prior to feeding till 20 minutes after a feeding event were considered. From these sets of images, all images prior to when feeding began were given a score of 0, and all images after feeding ended were given a score of 1. For the images captured during the feeding event, image i was given a score s by interpolating between 0 and 1, as shown in Equation 1:

$${s}_{i} = f ( t ) = ( \frac{{t}_{i} - {t}_{begin}}{{t}_{begin} - {t}_{end}} ) . \qquad ( 1 )$$

where t_{begin} is the time when feeding began and tend is the time when feeding ended.

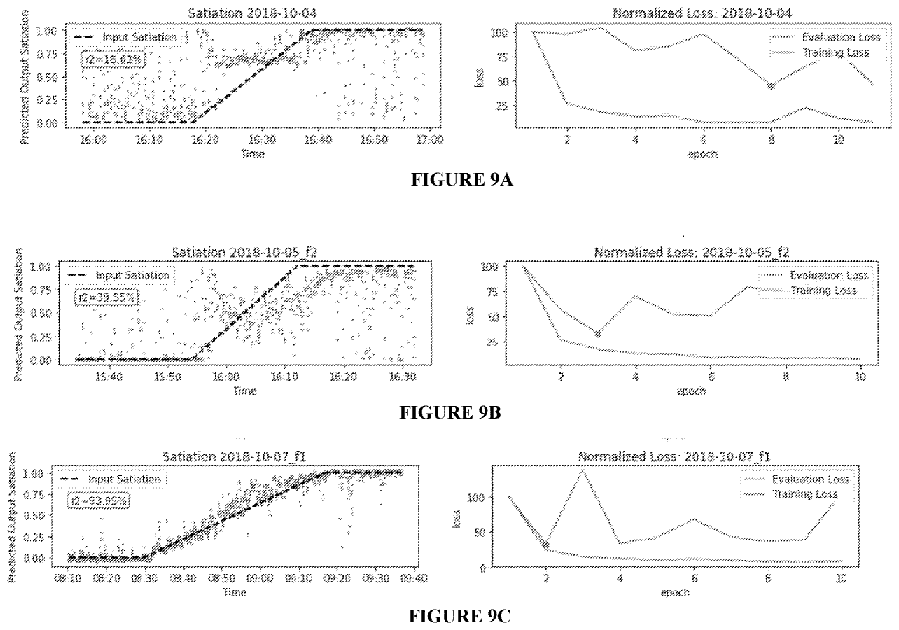

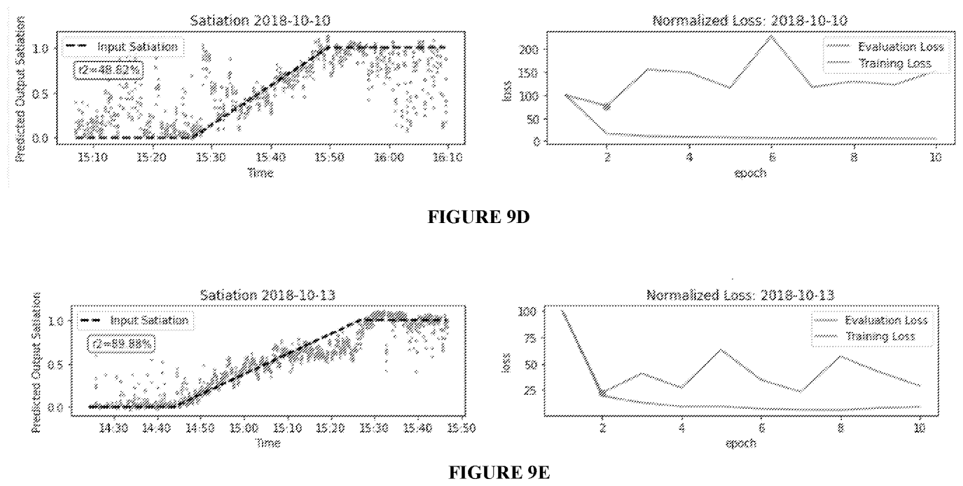

The network was then trained on these images and the satiation score annotations. For evaluating the network, the network was trained on all feeding events except one, and then tested it on that day, i.e., leave-one-day-out cross validation. A representative sample of the results is shown in FIGS. 9A-9E. The small dots correspond to the predicted satiation score, the dotted line corresponds to the linear satiation model based on logged feeding start and end times.

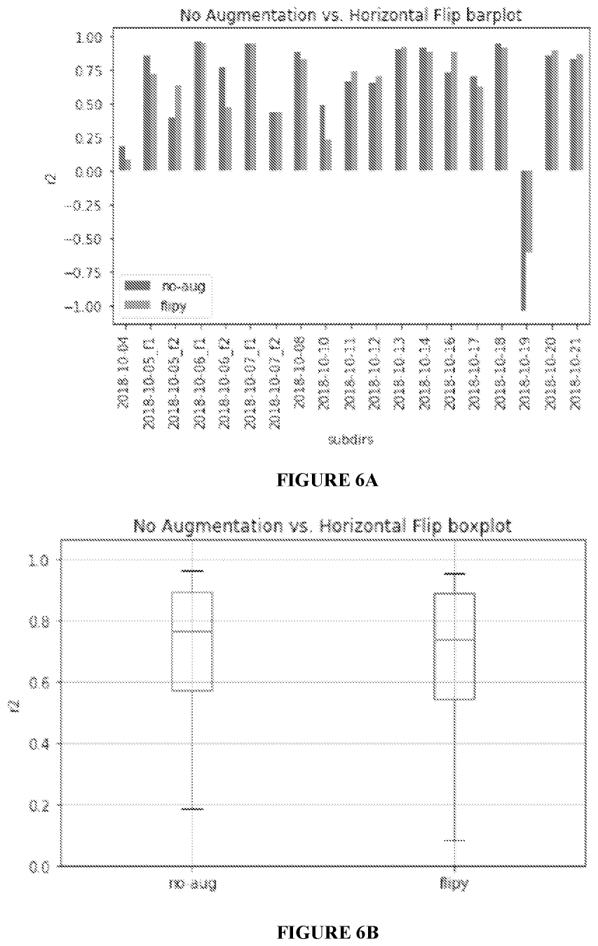

The network estimates satiation level on most days. Fish might move around the feeding tube in different direction (clockwise vs counterclockwise), and hence a network that is invariant to the swimming direction of the fish would perform better. A swim direction invariant network was trained by augmenting the input data with images that are flipped along the vertical axis. However, doing this results in no statistically significant change to the network performance. FIG. 6A and FIG. 6B show the data augmentation via incorporating images flipped along the vertical axis.

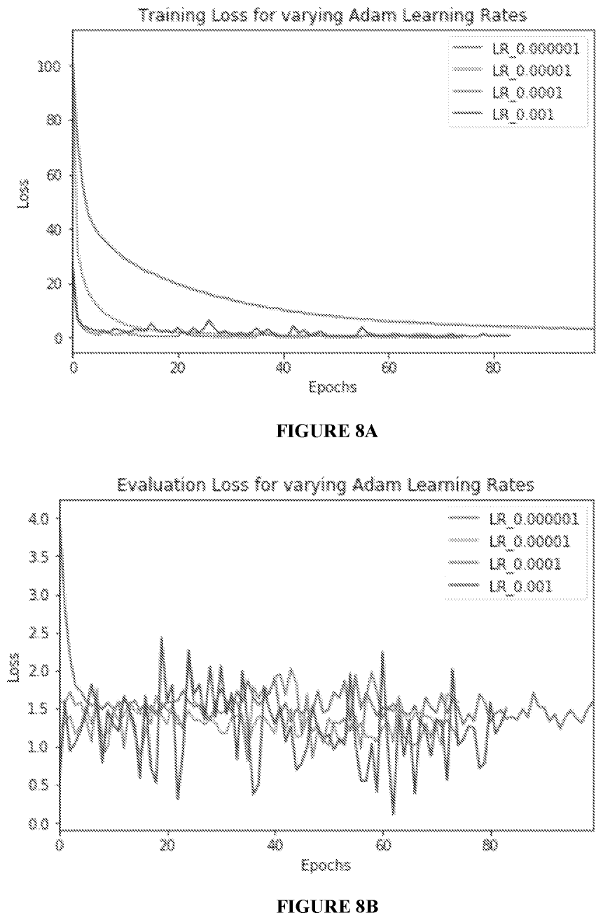

The ADAM optimizer was used for training the network, which has been shown to have good out of the box performance on many different types of networks. However, the non-smooth evaluation loss plots shown in FIGS. 9A-9D indicate that the default learning rate of 0.001 might be too high. The results of smaller learning rates and longer training times are shown in FIGS. 8A and 8B. Although setting the learning rate lower does make the evaluation loss smoother, it does not substantially improve the performance of the network. Thus, the default learning rate of 0.001 is sufficient.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art and are within the following claims

For the purpose of understanding the aquaculture monitoring system and method references are made in the text to exemplary embodiments of a monitoring system and method, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Although the invention has been described with reference to the above examples, it will be understood that modifications and variations are encompassed within the spirit and scope of the invention. Accordingly, the invention is limited only by the following claims.

1. A method for underwater environmental monitoring of underwater creature satiation, comprising the steps of:
a) providing a detector comprising at least one sensor, a controller, and a power source, wherein said power source is electrically connected to said sensor and said controller;
b) capturing data on the underwater environment with said at least one sensor;
c) transmitting said data from said sensor to said controller wherein said controller comprises a plurality of nodes configured to be arranged in a processing pipeline to process said data; and
d) determining, with said controller, at least one parameter of said underwater environment using said data.

2. The method of claim 1 wherein said sensor comprises a stereo image collector and at least one of said plurality of nodes converts stereo images collected by the sensor to depth maps.

3. The method of claim 2 wherein said data further comprises biomass of objects within said underwater environment and wherein at least one of said plurality of nodes determines which of said depth maps are suitable for analyzing underwater environments wherein said biomass is dense.

4. The method of claim 1 wherein said at least one parameter comprises fish feeding state.

5. The method of claim 4 wherein at least one of said plurality of nodes comprises estimating a satiation score using said fish feeding state parameter.

6. The method of claim 1 wherein said data comprises images of said underwater environment that comprise at least one individual object and at least one of said plurality of nodes comprises a machine learning-based technique for detecting said at least one individual object.

7. The method of claim 1 wherein said data comprises images of said underwater environment that comprise at least one individual object and at least one of said plurality of nodes is a training node that detects said individual objects at a set angle.

8. The method of claim 7 wherein said individual objects comprise fish said training node detects those fish which are straight-bodied.

9. The method of claim 1 wherein said at least one parameter comprises fish length.

10. The method of claim 9 wherein said at least one other parameter comprises at least one key point consisting chosen from the following: length from said fish mouth to tail, length of said fish head, length of said fish tail.

11. The method of claim 9 wherein said at least one node comprises analyzing a pre-defined fish 3D model to estimate said key points.

12. The method of claim 1 wherein said data comprises images of said underwater environment and wherein said underwater environment comprises a plurality of underwater creatures and said at least one plurality of nodes comprises classifying said images into one of three categories consisting of pre-feeding, during-feeding, or post-feeding so that each said images is assigned a classification output.

13. The method of claim 12 wherein at least one of said plurality of nodes transforms said classification outputs into a scale ranging from 0 to 1 which correspond to underwater creature satiation so that said at least one parameter is underwater creature satiation.

14. The method of claim 1 wherein said data comprises images of said underwater environment that comprise at least one individual object and at least one parameter comprises object mass and a second at least one parameter comprises expected number of objects.

15. The method of claim 1 further comprising the step of, after said determining step, processing said at least one parameter with at least one node to produce an estimated parameter.

16. The method of claim 15 wherein said at least one parameter comprises object mass and a second at least one parameter comprises expected number of objects and said estimated parameter comprises overall object mass in said underwater environment.

17. The method of claim 1 wherein said determining step further comprises processing additional data not gathered by said sensor.

18. The method of claim 1 wherein at least one said plurality of nodes is chosen from the group consisting of: detecting anomalies in said data; enabling rare said parameter detection; and determining structural integrity of objects in said underwater environment.

19. A non-transient computer readable medium containing program instruction for causing a computer to perform the method of:
a) receiving images from a sensor deployed in an underwater environment comprising underwater creatures; and
b) constructing a processing pipeline by selecting a subset of nodes from a plurality of nodes, said nodes representing computational steps for processing data and wherein at least one of said plurality of nodes selected is classifying said images into one of three categories consisting of underwater creature pre-feeding, underwater creature during-feeding, or underwater creature post-feeding so that each said images is assigned a classification output transforming said classification output into a scale ranging from 0 to 1 which corresponds to underwater creature satiation.

20. A non-transient computer readable medium containing program instruction for causing a computer to perform the method of:
a. receiving images from a sensor deployed in an underwater environment comprising fish;
b. constructing a processing pipeline by selecting a subset of nodes from a plurality of nodes, said nodes representing computational steps for processing said images;
c. analyzing said images with said processing pipeline, producing processed data; and
d. estimating at least one parameter of the environment with said processed data;
wherein processed data comprises fish mass and expected number of fish and said estimated at least one parameter comprises overall fish mass in said underwater environment.
